(19) United States
(12) Patent Application Publication
(10) Pub. No.: US 2007/0202294 A1
(43) Pub. Date: Aug. 30, 2007

(54) PROTECTIVE FIRE RETARDANT COMPONENT FOR A COMPOSITE FURNITURE SYSTEM

(75) Inventors: Steven E. Ogle, Murfreesboro, TN (US); D. Patrick Steagall, Mooresville, NC (US); Karl Van Becelaere, Nashville, TN (US); K.C. Thompson, Antioch, TN (US)

Correspondence Address: CONLEY ROSE, P.C., 5700 GRANITE PARKWAY, SUITE 330, PLANO, TX, 75024, US

(73) Assignee: L&P Property Management Company, South Gate, CA (US)

(21) Appl. No.: 11/677,980

(22) Filed: Feb. 22, 2007

Related U.S. Application Data
(63) Continuation-in-part of application No. 11/088,658, filed on Mar. 23, 2005.
(63) Continuation-in-part of application No. 11/584,190, filed on Oct. 20, 2006.
Application No. 11/584,190 is a division of application No. 10/968,339, filed on Oct. 18, 2004, now Pat. No. 7,125,460.
(63) Continuation-in-part of application No. 10/968,318, filed on Oct. 18, 2004, now Pat. No. 7,244,322.
Application No. 10/968,318 is a continuation of application No. 10/221,638, filed on Jan. 7, 2003, now Pat. No. 7,147,734.
(60) Provisional application No. 60/556,136, filed on Mar. 23, 2004.
(60) Provisional application No. 60/542,263, filed on Feb. 3, 2004.
(60) Provisional application No. 60/188,979, filed on Mar. 13, 2000.

(51) Int. Cl. B32B 1/04; B32B 3/02; B32B 27/20

(52) U.S. Cl. 428/68; 442/136; 442/138; 442/149; 442/414; 442/415; 442/417; 442/74; 428/74; 428/76; 428/920; 428/921; 428/102; 428/223

(57) ABSTRACT

A protective fire retardant (FR) component for a composite furniture system. The protective FR component includes a resilient FR fiber batt comprised of at least one FR material and a layer of material enclosing the resilient FR fiber batt. The FR materials used to form the resilient FR fiber batt may include oxidized polyacrylonitrile (O-PAN) fibers, FR rayon fibers, a fiber blend which includes both O-PAN fibers and FR rayon fibers, modacrylic fibers or a fiber blend which includes both FR rayon fibers and modacrylic fibers.

### CROSS-REFERENCE TO RELATED APPLICATIONS

This application is a Continuation-In-Part of pending U.S. patent application Ser. No. 11/088,658, filed Mar. 23, 2005, entitled “Gray Fire Resistant Nonwoven Batt Formed From A Blend Of Fire Retardant Materials And An Associated Method Of Manufacturing The Same,” which is based on and claims priority from U.S. Provisional Patent Application Ser. No. 60/556,136 filed Mar. 23, 2004, entitled “Gray Fire Resistant Nonwoven Batt”, both of which are hereby incorporated by reference as if reproduced in their entirety.

This application is also a Continuation-In-Part of pending U.S. patent application Ser. No. 11/584,190, filed Oct. 20, 2006, entitled “Bi-Layer Fire Resistant Nonwoven Fiber Batt Having Charring And Oxygen-Depleting Fibers In Each Layer Thereof”, which is a Divisional application of U.S. patent application Ser. No. 10/968,339, filed Oct. 18, 2004, entitled “Fire Resistant Nonwoven Batt Having Charring And Oxygen-Depleting Fibers,” now U.S. Pat. No. 7,125,460, which, in turn, is based on and claims priority from U.S. Provisional Patent Application Ser. No. 60/542,263 filed Feb. 3, 2004, entitled “Fire Resistant Nonwoven Batt”, all of which are hereby incorporated by reference as if reproduced in their entirety.

This application is also a Continuation-In-Part of pending U.S. patent application Ser. No. 10/968,318, filed Oct. 18, 2004, entitled “Method For Forming Fire Combustion Modified Batt”, which is a Continuation of U.S. patent application Ser. No. 10/221,638, filed Sep. 13, 2002, entitled “Method For Forming Fire Combustion Modified Batt”, now U.S. Pat. No. 7,147,734, which is based on and claims priority from International Patent Application PCT/US01/07831, filed Mar. 13, 2001, which, in turn, is based on and claims priority from U.S. Provisional Patent Application Ser. No. 60/188,979, filed Mar. 13, 2000, entitled “Bi-Lofted Fire Combustion Modified Batt”, all of which are hereby incorporated by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

This disclosure relates to protective fire resistant (FR) structures and, more particularly, to protective FR structures which, when deployed as a component of a composite furniture system, protects the composite furniture system if exposed to a flame or other source of ignition.

### BACKGROUND

The dangers associated with household fires are well known to all. As a result, there is a constant demand for new products that enhance fire safety in homes and other residential structures. Within the home, composite furniture systems, for example, sofas and mattresses, incorporating a large number of combustible components often contribute to the propagation of a fire through the house or other structure. The short reaction time commonly associated generally with residential fires involving composite furniture systems and, in particular, to bedroom fires occurring at night, has resulted in a variety of efforts directed towards enhancing the fire resistance of the various composite furniture systems commonly found in the home.

Many of these efforts have focused on the components of the bed, specifically, the mattress and/or box spring. Like many other composite furniture systems, mattresses have traditionally contained a number of combustible materials, for example, fabrics and/or nonwoven fiber batts containing cotton or other flammable materials. Compounding the problem for mattresses and certain other composite furniture systems such as sofa, chairs and other types of upholstered furniture, are the compressed springs typically found in the interior thereof. For example, as a fire begins to consume a mattress, the structure that keeps the springs within the mattress weakens. Eventually, the compressed springs will punch through the structure, thereby exposing additional combustible material to the fire.

In recent years, a number of FR standards for mattresses have been developed by legislative bodies, administrative agencies and/or private organizations. Among them are the Federal Standard for Flammability of Mattresses and Mattress Pads set forth in 16 C.F.R. § 1632. Other FR standards for mattresses include: American Society of Testing and Materials (ASTM) E-1590, National Fire Prevention Association (NFPA) 267, Underwriter's Laboratories (UL) 1895 and California Technical Bulletins (TBs) 117, 129, and 603. Cognizant of the increasing extent of government regulation in this area and in growing recognition of the dangers associated with mattress fires, almost every mattress manufacturer in the United States has developed, or is in the process of developing, mattress designs having enhanced FR characteristics relative to their prior mattress designs. As a result, newly manufactured mattresses in compliance with one or more of the aforementioned FR standards are becoming increasingly common. Unfortunately, while newly manufactured mattresses in compliance with FR standards are readily available, large numbers of pre-existing flammable mattresses remain in use. While the immediate replacement of all remaining flammable mattresses would be ideal, the high cost of new mattresses serves to act as a strong disincentive to the replacement of older, flammable, mattresses before the end of their useful lifespan.

An FR mattress cover is a mattress pad or other type of enclosure at least partially formed using FR materials. Typically, FR mattress covers tend to enhance the FR characteristic of mattresses enclosed thereby by slowing the ignition of any combustible materials forming part of the enclosed mattresses. As a result, FR mattress covers are widely seen as an inexpensive solution to the continued use of flammable mattresses. Because they are uncomfortable to sleep on, however, existing FR mattress covers are not widely used. More specifically, existing FR mattress covers typically contain hard, rigid, and/or non-lofty materials, such as fiberglass and asbestos. When these materials are placed in a mattress cover and the cover placed over a mattress, what was previously a relatively soft mattress will immediately feel hard and rigid. Unfortunately, comfort is a leading criteria used by consumers when evaluating mattresses. As a result, consumers owning flammable mattresses will oftentimes decide to either: (1) not purchase a FR mattress cover because the use of the mattress cover will make the bed uncomfortable, or (2) remove a FR mattress cover that has already been purchased even though removal of the FR mattress cover will dramatically increase the risk of a mattress fire. Thus, while FR mattress covers capable of reducing the vulnerability of mattresses covered thereby to fire are known, they have never achieved wide acceptance with consumers. As a result, many older, flammable, mattresses unnecessarily remain vulnerable to fire.

Another problem with existing FR mattress covers that employ fiberglass relates to the tendency of the fiberglass to produce glass shards capable of irritating the skin. More specifically, when a FR mattress cover includes a fiberglass substrate, the fiberglass substrate tends to fracture into glass shards when exposed to repeated bending stresses such as those produced by a person rolling around in or sitting on the side of a bed. When the fiberglass fractures, the resultant glass shards are capable of migrating, through the FR mattress cover and bed sheets, to the sleeping surface of the bed. Once on the sleeping surface, the glass shards may become embedded in the skin of a person sleeping or otherwise resting on the bed, thereby causing that person to itch. As before, for too many consumers, the discomfort resulting from use of the FR mattress cover typically overrides any perceived need for protection from fire, thereby resulting in removal of the offending FR mattress cover.

Consequently, a need exists for a FR mattress cover which, by overcoming the shortcomings of prior FR mattress covers, is capable of achieving widespread acceptance among consumers who choose to continue using flammable mattresses and any others who are not permitted to choose their sleeping arrangements and may be obligated to use a flammable mattress.

Further, as many of the foregoing considerations are equally applicable to other types of composite furniture systems, for example, upholstered furniture, for which there may be a need to enhance the FR characteristic of the furniture without requiring the replacement of the article of furniture itself, a need also exists for an FR cover which applies the principles of the aforementioned FR mattress cover to a wide variety of other composite furniture systems, e.g., upholstered furniture such as sofas and chairs, pillows and the like.

### SUMMARY

In embodiments thereof, disclosed herein is a cover suitable for use as a protective FR component of a composite furniture system and a composite furniture system incorporating the same. The protective FR component is comprised of a resilient FR fiber batt, which includes at least one type of FR material and a layer of material enclosing the resilient FR fiber batt. In certain aspects of this embodiment, the layer of material enclosing the resilient FR fiber batt may include a top cover and a backing portions mated to respective sides of the resilient FR fiber batt. Alternately, the backing may be a woven fabric or a nonwoven fiber batt. In further aspects thereof, the top cover, resilient FR fiber batt and backing may be quilted to one another or, in the alternative, attached to one another by a first heat-activated layer of adhesive provided between the top cover and the resilient FR fiber batt and a second heat-activated layer of adhesive provided between the resilient FR fiber batt and the backing.

In still further aspects of this embodiment, the resilient FR fiber batt may be comprised of at least one charring fiber. Suitable charring fibers may include, among others, oxidized polyacrylonitrile (O-PAN), FR rayon or both. Alternately, the resilient FR fiber batt may be formed from a blend of FR fibers which may include O-PAN fibers, FR rayon fibers, both O-PAN and FR rayon fibers, modacrylic fibers, or both FR rayon and modacrylic fibers.

### BRIEF DESCRIPTION OF THE DRAWINGS

For a more complete understanding of the present invention, and for further details and advantages thereof, reference is now made to the accompanying drawings, in which:

FIG. 1 is a perspective view of a composite furniture system having first and second protective FR components enclosing first and second components, respectively, of the composite furniture system.

FIG. 2A is a cross-sectional end view of the composite furniture system of FIG. 1, taken along section line 2A-2A thereof.

FIG. 2B is a cross-sectional end view of the composite furniture system of FIG. 1 having only a single protective FR component enclosing both the first and second components of the composite furniture system, the single protective FR component being of a type generally similar to the FR components illustrated in FIGS. 1 and 2A.

FIG. 2C is a cross-sectional end view of the composite furniture system of FIG. 1 when instead protected by a single protective FR component having a first alternate configuration.

FIG. 2D is a cross-sectional end view of the composite furniture system of FIG. 1 when instead protected by a single protective FR component having a second alternate configuration.

FIG. 3A is a perspective view of a second composite furniture system enclosed by one of the protective FR components of FIGS. 1 and 2A, the protective FR component having now been configured to include a first enclosure system.

FIG. 3B is a perspective view of the second composite furniture system of FIG. 3A enclosed by one of the protective FR components of FIGS. 1 and 2A, the protective FR component having now been configured to include a first alternate enclosure system.

FIG. 3C is a partial inverted perspective view of the composite furniture system of FIG. 3A, enclosed by one of the FR components of FIGS. 1 and 2A, the protective FR component having now been configured to include a second alternate enclosure system.

FIG. 4 is a partial cross-sectional view of one of the protective FR components of FIG. 2A.

FIG. 5 is a flow chart illustrating a method of forming a nonwoven FR fiber batt used to form the protective FR components of FIGS. 2A-4.

FIG. 6 is a side view of a nonwoven FR fiber batt constructed in accordance with the method of FIG. 5.

FIG. 7 is a top plan view of a processing line suitable for use in forming the nonwoven FR fiber batt of FIG. 6.

FIG. 8 is a side view of an alternate embodiment of a nonwoven FR fiber batt constructed in accordance with the method of FIG. 5.

FIG. 9 is a side view of a second alternate embodiment of a nonwoven FR fiber batt constructed in accordance with the method of FIG. 5.

### NOTATION AND NOMENCLATURE

Certain terms are used throughout the following description and claims to refer to particular system components. This document does not intend to distinguish between components that differ in name but not function.

In the detailed description and claims that follow, the terms “including” and “comprising” are used in an open-ended fashion, and thus should be interpreted to mean “including, but not limited to.”

The term “basis weight” of a nonwoven fiber batt generally refers to the weight (in ounces) of a square foot of the nonwoven fiber batt.

The term “charring fibers” generally refers to inherently flame resistant fibers that carbonize into a charred fiber but will maintain a stable physical structure when exposed to an external source of ignition.

The term “compact nonwoven fiber batt” generally refers to a nonwoven fiber batt having a height (in inches) between about two-thirds and one times its basis weight (in ounces). For example, a nonwoven fiber batt having a basis weight of about one ounce per square foot and a height of between about two-thirds of an inch and about one inch is a compact nonwoven fiber batt.

The term “densified nonwoven fiber batt” generally refers to a nonwoven fiber batt having a height (in inches) less than about two-thirds of its basis weight (in ounces) For example, a nonwoven fiber batt having a basis weight of about one ounce and a height of less than about two-thirds of an inch is a densified nonwoven fiber batt.

The terms “enhanced FR characteristic” and “enhanced non-FR characteristic” generally refer to modifications that enable a component to resist being consumed by flame for a longer period of time than it would in the absence of the modification. For example, if the FR characteristic of the modified component enables the component to meet a selected flammability standard, the modified component has an enhanced FR characteristic. Conversely, if the FR characteristic of the modified component does not enable the component to meet the selected flammability standard, the modified component has an enhanced non-FR characteristic. An FR characteristic or a non-FR characteristic may be enhanced by modification of the component itself, for example, by adding inherently FR fibers to a blend of fibers or by creating an obstruction between the component and a flame or other source of ignition, for example, by partially or fully enclosing the component within a second, typically FR, component.

The terms “fire retardant” or “FR” generally refer to a component that bums slowly or is self-extinguishing after removal of an external source of ignition, such as a flame. As used herein, the characterization of a component as being “FR” depends on whether it meets or exceeds the requirements of a flammability standard against which it is being tested or otherwise considered. For example, a mattress tested against the flammability standards for mattresses set forth in California TB 129 would be considered “non-FR” if a flame test performed in accordance with the test procedures set forth in TB 129 revealed that the mattress experienced: (1) a weight loss due to combustion of 3 pounds or greater in the first ten minutes of the test; (2) a maximum rate of heat release of 100 kW or greater; or (3) a total heat release of 25 MJ or greater in the first ten minutes of the test. Also, both individual components, such as a mattress, for example, or a combination of components of a furniture system, such as a foundation in combination with a mattress supported thereby, for example, may be classified as FR.

The term “flammability standard” generally refers to an objective measurement used to determine the flammability of a component. As used herein, a flammability standard encompasses both formal standards established by legislative bodies, administrative and/or other governmental agencies and private organizations as well as informal standards, such as observations made during an exposure of at least one component to a source of ignition.

The term “FR characteristic” generally refers to a component's ability to resist consumption by flame. As used herein, the term provides a scale by which the relative FR of multiple components may be weighed. For example, a first component having a “greater” FR characteristic would resist being consumed by flame for a longer period of time than a second component having a “lesser” FR characteristic.

The term “FR treated cotton” generally refers to cotton fibers to which a suitable flame retardant chemical is applied, thereby effectively rendering the cotton fibers inherently fire resistant.

The term “FR treated rayon” generally refers to rayon fibers to which a suitable flame retardant chemical is applied, thereby effectively rendering the rayon fibers inherently fire resistant.

The terms “inherently fire resistant” or “inherently FR” generally refer to a material, for example, O-PAN that is classified as being FR because of the innate properties of the material.

The term “high loft nonwoven fiber batt” generally refers to a nonwoven fiber batt having a height (in inches) greater than its basis weight (in ounces). For example, a nonwoven fiber batt having a basis weight of about one ounce and a height of more than about one inch is a high loft nonwoven fiber batt.

In addition to its usual and customary meaning, the term “melt” or “melting” shall also refer to the gradual transformation of a fiber or, in the case of a bicomponent sheath/core fiber, the sheath of the fiber, over a range of temperatures within which the fiber becomes sufficiently soft and tacky to cling to other fibers with which it comes in contact.

The terms “non-fire retardant,” “non-FR” and “flammable” all refer generally to materials, for example, untreated cotton fibers, that will burn quickly, even after removal of an external source of ignition.

The term “oxygen-depleting fiber” generally refers to those fibers which generate oxygen-depleting gases when exposed to flame.

### DETAILED DESCRIPTION

It should be understood that the present invention is susceptible to various modifications and alternative forms, specific embodiments of which are, by way of example, shown in the drawings and described in detail herein. It should be further understood, that the drawings and detailed description set forth herein are not intended to limit the invention to the particular form disclosed. On the contrary, the intention is to cover all modifications, equivalents and alternatives falling within the spirit and scope of the present invention as defined by the claims appended hereto.

Turning now to the Figures, a protective FR component suitable for use in conjunction with a composite furniture system will now be described in greater detail. As may now be seen, FIG. 1 shows a composite furniture system, specifically, a sleeping system 10, for example, a conventionally configured bed. The sleeping system 10 is comprised of a first component (not visible in FIG. 1), for example, a non-FR mattress (also periodically referred to hereafter as a “flammable mattress”) fully enclosed by a first protective FR component 100a and a second component (also not visible in FIG. 1), for example, a non-FR foundation (also periodically referred to hereafter as a “flammable foundation”) fully enclosed by a second protective FR component 100b. As will be more fully described below, each protective FR component 100a, 100b protects a component of a sleeping system, in the disclosed example, a non-FR mattress and a non-FR foundation, respectively, by fully enclosing the component to be protected.

It should be recognized that, relative to one another, the extent to which the FR characteristic of various combinations of protective FR components and non-FR components of composite furniture systems, such as mattresses, foundations or other components of sleeping systems, is enhanced may vary based upon any number of other considerations, for example, differences in the flammability characteristics of the non-FR mattresses, foundations or other components of sleeping systems fully enclosed by the protective FR components, differences in the FR characteristics of the fiber batt, loose fibers or other type of fiberfill used to fill the protective FR component and/or whether or not the protective FR components are provided with FR top cover members. As will be appreciated to one skilled in the art, enhancement of the FR characteristic of the combination of a protective FR component and a non-FR mattress, foundation or other component of a sleeping system will improve the ability of the combination to withstand a longer exposure to a source of ignition and/or an exposure to fire of greater intensity.

Preferably, the protective FR components sufficiently enhance the FR characteristic of non-FR mattresses, foundations or other components of sleeping systems protected thereby such that all of the various combinations of protective FR components and non-FR mattresses, foundations or other components of the sleeping system would be deemed FR. It should be recognized, however, that, depending on variables such as the FR characteristics of the protective FR components employed and the flammability of the non-FR mattresses, foundations and/or other components of sleeping systems fully enclosed by the protective FR components, the FR characteristic of the combination of a protective FR component system and a non-FR mattress, foundation or other component of the sleeping system fully enclosed thereby may be enhanced but not rendered FR.

Heretofore, only the full enclosure of a non-FR mattress, foundation or other component of the sleep system by a protective FR component has been disclosed. However, it is further contemplated that protective FR components may instead be used to partially enclose a non-FR mattress, foundation or other component of a sleep system. In such configurations, the FR characteristic of the combination of the protective FR component and the non-FR mattress, foundation or other component or components (including all components) of the sleep system would preferably be sufficiently enhanced such that the combination of the protective FR component and the non-FR mattress, foundation or other component or components of the sleeping system is rendered FR. However, it is noted that the extent to which a protective FR component encloses a non-FR mattress, foundation or other component of a sleeping system will affect whether or not the FR characteristic of the combination of a particular protective FR component and a particular non-FR mattress, foundation or other component or components of a sleeping system is sufficiently enhanced to render the resultant combination FR or if the FR characteristic of the combination is merely enhanced such that the combination would remain non-FR.

Thusfar, the use of protective FR components has been disclosed in conjunction with the full or partial enclosure of non-FR mattresses, non-FR foundations or other non-FR components of a sleeping system such that the combination of the protective FR component and the non-FR mattress, non-FR foundation or other non-FR component or components of a sleeping system is either rendered FR or, at a minimum, non-FR with an enhanced FR characteristic. However, it is further contemplated that the protective FR components may also be employed in combination with FR mattresses, FR foundations or other FR component or components of a sleeping system such that, while remaining FR, the combination of the protective FR component and the FR mattress, FR foundation or other FR component or components of a sleeping system would have an enhanced FR characteristic. Finally, while the protective FR component is disclosed herein in conjunction with a sleeping system, it is fully contemplated that the protective FR component system has other applications, for example, for enhancing the FR characteristic of other consumer products subject to flammability standards.

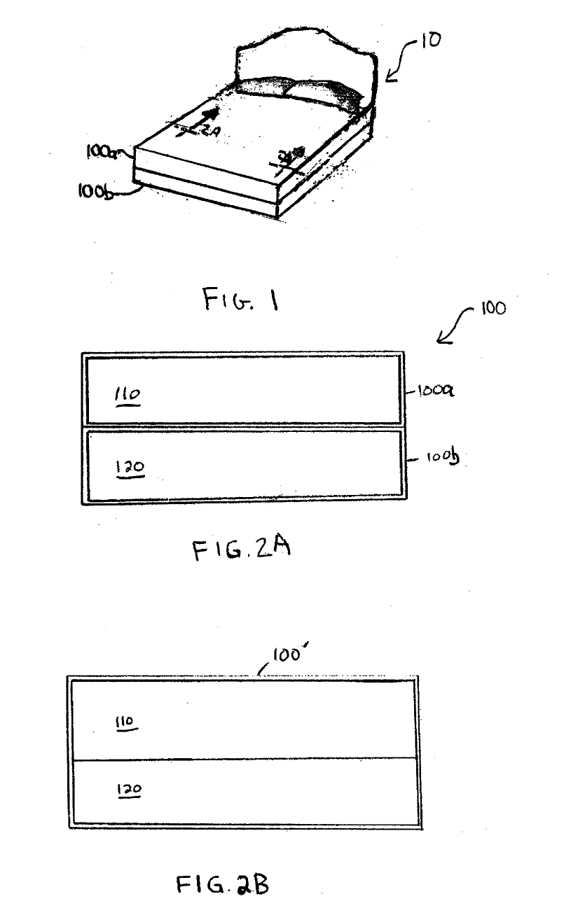

Turning now to the remaining ones of the drawings, a protective FR component constructed in accordance with the teachings set forth herein will now be described in greater detail. FIG. 2A is a cross-sectional end view of the sleeping system 10 taken along section line 2A-2A of FIG. 1. As may now be seen, a protective FR component 100 is comprised of first and second protective components 100a, 100b. In an embodiment, the first and second protective FR components 100a and 100b may generally be identical to one another and deployed in the manner described herein to protect a non-FR mattress 110 and a non-FR foundation 120, respectively, of the sleeping system 10. As may be further seen, each protective FR component 100a, 100b fully encloses the respective one of the non-FR mattress 110 and non-FR foundation 120 for which it has been deployed.

It has been recognized that certain advantageous features are associated with the particular configuration of the protective FR component 100 illustrated in FIG. 2A. More specifically, the protective FR component 100 of FIG. 2A is advantageous because it provides a first separate and discrete fire barrier (the protective FR component 100a) for the non-FR mattress 110 in the event that the non-FR foundation 120 catches fire. Similarly, the protective FR component 100 further provides a second separate and discrete fire barrier (the protective FR component 100b) for the non-FR foundation 120 in the event that the non-FR mattress 110 catches fire. Without separate and discrete fire barriers, both the non-FR mattress 110 and the non-FR foundation 120 are exposed to fire in the event that the fire barrier protecting one of the two is breached. In addition, by deploying the protective FR component 100 in the form illustrated in FIG. 2A, first and second protective FR components 100a and 100b may be handled separately. As a result, the protective FR component 100 would be viewed by some users as being easier to install. Finally, when a protective FR component 100 comprised of first and second protective FR components 100a, 100b is deployed in a manner similar to that illustrated in FIG. 2A, it is possible to rotate the non-FR mattress 110 enclosed thereby without disassembling the protective FR component 100 itself.

While FIG. 2A illustrated one configuration of the protective FR component 100, it should be clearly understood that there are a variety of other configurations by which the protective FR component 100 may be deployed to protect a mattress, foundation and/or other component of the sleeping system 10. More specifically, it is fully contemplated that the protective FR component 100 may be configured to either fully enclose a mattress or foundation, partially enclose a mattress or foundation, fully enclose both the mattress and the foundation, fully enclose either the mattress or foundation and partially enclose the other, or partially enclose both the mattress and the foundation. Of course, the foregoing are just some of the various configurations of the protective FR component 100 that are possible, and it is fully contemplated that the protective FR component 100 encompasses configurations other than those specifically described and/or illustrated herein.

It is further contemplated that the mattress 110 may be any type of conventional sleeping mattress, including, but not limited to, adult mattresses, youth mattresses, futons, water beds, air mattresses, crib mattresses, bunk bed mattresses, mattresses used in upholstered furniture such as convertible sofa bed mattresses, comer group mattresses, day bed mattresses, roll-a-way bed mattresses, high risers, and trundle bed mattresses. In addition, the mattress 110 may be any type of structure that falls under the definition of a “mattress” as set forth in 16 C.F.R. § 1632.1(a). Similarly, it is contemplated that the foundation 120 may be any type of structure used to support the mattress 110, including, but not limited to, a box spring assembly or a second mattress. In addition, the foundation 120 may be any type of structure that falls under the definition of a “foundation” as set forth in 16 C.F.R. § 1632.8(r). Finally, it is contemplated that the mattress 110 and the foundation 120 may be constructed using any one or combination of a variety of components, including, but not limited to, springs, foams and fibers. In this regard, it should be clearly understood that each of the foregoing components specifically identified herein includes all types and/or structures associated with the recited component. For example, it is contemplated that some of the different types and/or structures that are encompassed by the term “fibers” include, but are not limited to, natural fibers, synthetic fibers, staple fibers, cluster fibers, fiberfill, woven fibers, nonwoven fibers, fiber webs and fiber batts.

Referring next to FIG. 2B, an alternate configuration of the protective FR component 100 may now be seen. In this configuration, a single protective FR component, specifically, protective FR component 100′, is used in place of the first and second protective FR components 100a and 100b to protect the sleeping system 10 of FIG. 1. Thus, in FIG. 2B, the non-FR mattress 110 and the non-FR foundation 120 are fully enclosed by a single protective FR component 100′. Of course, to fully enclose both the non-FR mattress 110 and the non-FR foundation 120, it is contemplated that the protective FR component 100′ be sized considerably larger than either of the protective FR components 100a or 100b illustrated in FIG. 2A. Of course, the appropriate dimensions for the protective FR component 100′, as well as for the protective FR components 100a, 100b and any other protective FR components or components to be hereinbelow described, will vary depending on the dimensions of the component or components of the sleeping system 10, or the composite furniture system or components thereof, to be protected by the protective FR component 100′ or the protective FR components 100a, 100b.

Of course, like the protective FR component 100 of FIG. 2A, there are a number of advantages associated with the particular configuration of the protective FR component 100′ illustrated in FIG. 2B. For example, many users prefer the protective FR component 100′ over the protective FR component 100 because it treats the entire sleeping system 10 as a single unit. As a result, the FR characteristic of the sleep system 10 as a whole is enhanced upon completing installation of a single protective FR component. Likewise, consumers may be more inclined to purchase one, rather than two, protective FR components. Of course, there are a number of disadvantageous associated with the protective FR component 100′. In particular, rotation of the non-FR mattress 110 by itself cannot be readily accomplished when the mattress 110 is enclosed, together with the foundation 120, within a single protective FR component 100′. Instead, the protective FR component 100′ must be disassembled before it is possible to rotate the mattress 110.

Referring next to FIG. 2C, yet another alternate configuration of the protective FR component 100 may now be seen. Here, a single protective FR component, specifically, protective FR component 100″, extends over upper, first side and second side surfaces 110a, 110b and 110c of the non-FR mattress 110 to partially enclose the non-FR mattress 110 protected thereby. In this configuration, while covered by an upper side surface 120a of the non-FR foundation 120, bottom side surface 110d of the non-FR mattress 110 remains unprotected by the protective FR component 100″. Furthermore, apart from secondary effects resulting from the protection of the non-FR mattress 110 by the protective FR component 100″ and the covering of upper side surface 120a by the bottom side surface 110d of the non-FR mattress 110, the upper, first side, second side and bottom side surfaces 120a, 120b, 120c and 120d of the non-FR foundation 120 are unprotected by the protective FR component 100″. However, with no direct exposure to a flame or other source of ignition, both the bottom side surface 110d of the non-FR mattress 110 and the upper side surface 120a of the non-FR foundation 120 are reasonably well protected by the remainder of the non-FR mattress 110 and/or the non-FR foundation 120. Furthermore, while completely unprotected, the bottom side surface 120d of the non-FR foundation 120 is the least likely surface of the sleeping system 10 to be exposed to a flame or other source of ignition.

While admittedly leaving a number of side surfaces of both non-FR mattress 110 and non-FR foundation 120 with reduced levels of protection, a number of advantages are associated with this particular configuration of the protective FR component 100″. For example, as less material is required to construct the protective FR component 100″, the cost of the protective FR component 100″ may be less than other protective FR components, for example, the protective FR component 100′. Indeed, if the enhancement to the FR characteristic of the sleeping system 10 provided by the protective FR component 100″ is sufficient to deem the covered sleeping system comprised of the combination of the protective FR component 100″ and the sleeping system 10 to be FR, full enclosure of the non-FR mattress 110 and the non-FR foundation 120 should be viewed as an unnecessarily costly solution to the continued use of flammable mattresses and/or foundations by a segment of the population. Additionally, as it more closely resembles a traditionally configured mattress cover or even a fitted sheet, it is believed that many consumers would more readily accept the partial sleeping system-enclosing protective FR component 100″ illustrated in FIG. 2C rather than the full sleep system-enclosing protective FR component 100′ of FIG. 2B or the full sleep system-enclosing pair of protective FR components 100a, 100b of FIG. 2A. If so, a possible loss in the level of protection afforded by protective FR component 100″ relative to the protective FR components 100 or 100′ would be offset by the successful deployment of the protective FR component 100″ by a larger segment of the population endangered by flammable components of existing sleeping systems.

Finally, FIG. 2D illustrates the sleeping system 10 of FIG. 1 being protected by a single protective FR component 100′″ that is similar in design to the protective FR component 100″ illustrated in FIG. 2C. More specifically, in the embodiment described and illustrated herein, both the non-FR mattress 110 and the non-FR foundation 120 are partially enclosed by a single protective FR component 100′″. Of course, to partially enclose both the non-FR mattress 110 and the non-FR foundation 120, it is contemplated that the protective FR component 100′″ be sized considerably larger than the protective FR component 100″ illustrated in FIG. 2C. In FIG. 2D, a single protective FR component, specifically, the protective FR component 100′″, extends over upper, first side and second side surfaces 110a, 110b and 110c of the non-FR mattress 110 and first and second side surfaces 120b and 120c of the non-FR foundation 120 to partially enclose both the non-FR mattress 110 and the non-FR foundation 120 protected thereby. In this configuration, full protection is afforded to all of the exposed side surfaces of both the non-FR mattress 110 and the non-FR foundation 120. In further accordance with this configuration, only the lower side surface 110d of the non-FR mattress 110 and the upper and lower side surfaces 120a and 120b of the non-FR foundation 120 are not protected by the protective FR component 100′″. However, with no direct exposure to a source of ignition, both the lower side surface 110d of the non-FR mattress 110 and the upper side surface 120a of the non-FR foundation 120 are reasonably well protected by the remainder of the non-FR mattress 110 and/or the non-FR foundation 120 while the lower side surface 120d of the non-FR foundation 120 is the least likely of the surfaces to be exposed to a flame or other source of ignition.

The configuration of the protective FR component 100′″ illustrated in FIG. 2D is considered by some as advantageous in that a significant reduction in the size of the protective FR component 100′″ (when compared to the protective FR component 100′ of FIG. 2B) may be achieved in return for only a slight reduction in the enhancement of the FR characteristic of the sleeping system 10 resulting from deployment of the protective FR component 100′″. Further, when compared to the protective FR component 100″ of FIG. 2C, the protective FR component 100′″ of FIG. 2D offers significantly better enhancement of the FR characteristic of the sleeping system 10 in exchange for only a minor increase in the size of the protective FR component 100′″. Finally, in that the protective FR component 100′″ of FIG. 2D also bears a strong resemblance to a traditionally configured mattress cover or fitted sheet, the protective FR component 100′″ may share in certain ones of the benefits associated with the protective FR component 100″ of FIG. 2C, specifically the increased likelihood that the protective FR component 100′″ will be more readily accepted by a larger segment of the population.

For maximum enhancement of the FR characteristic of the sleeping system 100 in return for a minimal consumption of FR material, any of the embodiments of the protective FR component illustrated in FIGS. 2B-D may be modified by incorporating FR material only into that portion of the protective FR component which covers the upper side surface 110a of the non-FR mattress 110. While the enhancement of the FR characteristic provided by this particular configuration of the protective FR component would be less than that provided by the other configurations of the protective FR component, for example, the protective FR components 100, 100′, 100″, 100′″, protection would still be maintained for that portion of the sleeping system 100, specifically, the upper side surface 110a of the non-FR mattress 110, most likely to be exposed to a fire. While affording the least amount of FR enhancement of the sleeping system 10 protected thereby, this particular configuration of the protective FR component represents the most cost effective of the disclosed protective FR components. Furthermore, in that it closely resembles a mattress pad, this particular configuration of the protective FR component also has potential for greater commercial acceptance.

As previously set forth, the protective FR components 100, 100′, 100″ and 100′″ disclosed herein are configured to either partially or fully enclose various combinations of one or more non-FR mattresses, non-FR foundations and/or other non-FR components of a sleeping system to be protected thereby. To assist in the partial or full enclosure of these and other components of the sleeping system, it is contemplated that a variety of closures, attachment means and the like may be used. For example, it is contemplated that elastic straps, zippers, snaps, buttons, tie cords, drawstrings, hook-and-loop fasteners (i.e. VELCRO®) and/or straps would all prove useful in securing the partial or full enclosure of a non-FR mattress, foundation or other component of a sleeping system within a protective FR component. Of course, it is fully contemplated that a variety of closure systems and attachment means other than the particular closure systems and attachment means disclosed herein are suitable for the purposes contemplated herein.

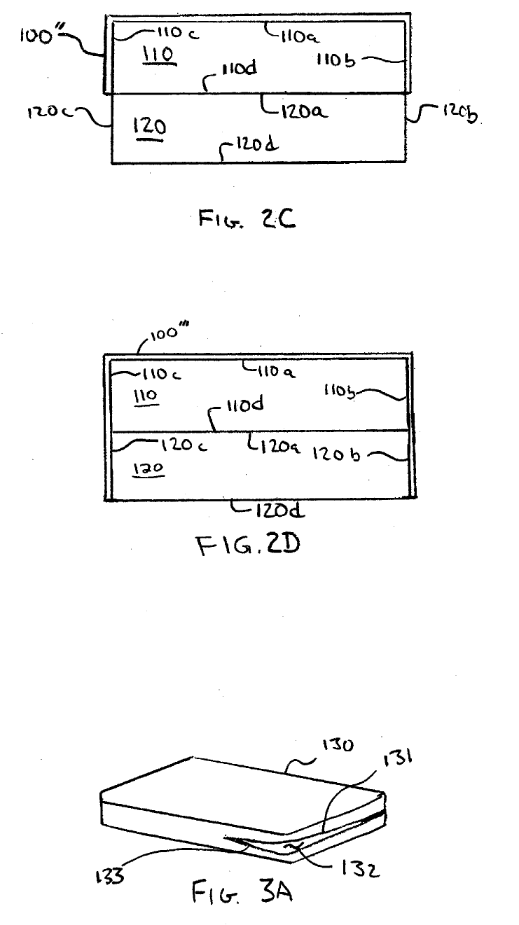

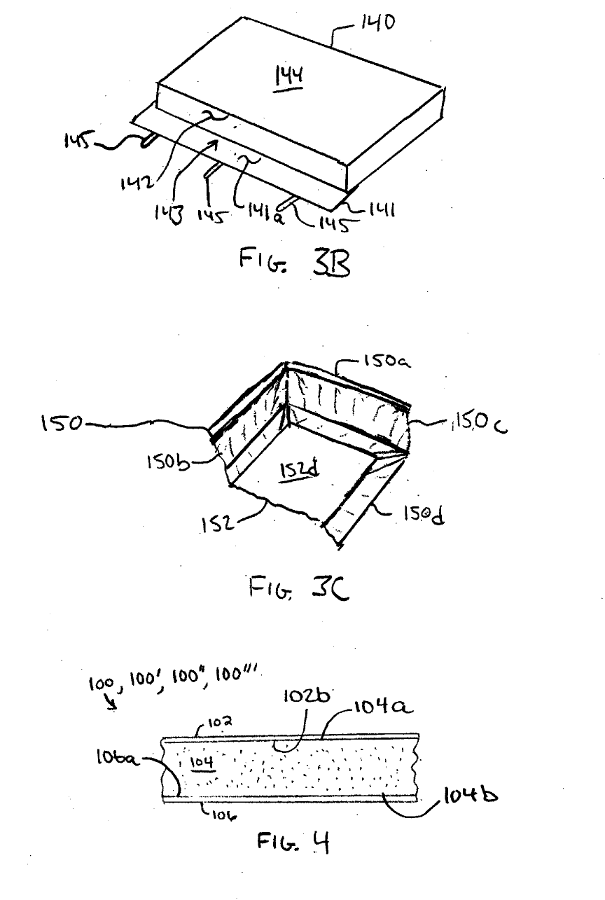

To fully enclose a non-FR mattress using a protective FR component similarly configured to the protective FR components 100, 100′ illustrated in FIGS. 2A and 2B, the protective FR component must be provided with an opening through which a non-FR mattress may be inserted. A protective FR component 130 equipped in this manner is shown in FIG. 3A. As may now be seen, interior side surfaces (not readily visible in FIG. 3A) of the protective FR component 130 define an interior volume which is accessible through aperture 131. A non-FR mattress 132 has been inserted through the aperture 131 where it fills the interior volume defined by the protective FR component 130. Preferably, the protective FR component 130 and aperture 131 therein are sized to readily receive the non-FR mattress 132 in the interior volume thereof without great difficulty. However, it is further preferred that the protective FR component 130 is sized such that, after insertion of the non-FR mattress 132, most, if not all, of the interior volume is occupied by the non-FR mattress 132. Of course, while FIG. 3A illustrates a non-FR mattress 132 being fully enclosed by the protective FR component 130, it is fully contemplated that the protective FR component 130 may instead receive a non-FR foundation, a non-FR mattress supported by a non-FR foundation, another non-FR component of a sleeping system, a FR mattress, a FR foundation, a FR mattress supported by a FR foundation and/or another FR component of a sleeping system, or a combination of one or more non-FR mattresses, non-FR foundations, other non-FR components of a sleeping system, FR mattresses, FR foundations and/or other FR components of a sleeping system not specifically recited herein. Once inserted through the aperture 131 and into the interior volume of the protective FR component 130, the full enclosure of the mattress 132 within the protective FR component 130 is completed by closing the aperture 131. For example, a zipper assembly (not shown) fixedly attached to a periphery 133 of the aperture 131 may be used to close the aperture 131.

An alternate closure structure suitable for use with a protective FR component, for example, the protective FR components 100 and 100′ illustrated in FIGS. 2A and 2B, respectively, to fully enclose a non-FR mattress may be seen by reference to FIG. 3B. Again, interior side surfaces 141a of the protective FR component 140 define an interior volume which may be accessed by opening a wall, for example, sidewall 141 of the protective FR component 140. Once opened, a non-FR mattress 142 is inserted through opening 143 and into the interior volume of the protective FR component 140. Preferably, the protective FR component 140 and the opening therein are sized to readily receive the non-FR mattress 142 in the interior volume thereof without great difficulty. However, it is further contemplated that the protective FR component 140 is sized such that, after insertion of the non-FR mattress 142, most, if not all, of the interior volume is occupied by the non-FR mattress 142. Of course, while FIG. 3B illustrates a non-FR mattress 142 being fully enclosed by the protective FR component 140, it is fully contemplated that the protective FR component 140 may instead receive a non-FR foundation, a non-FR mattress supported by a non-FR foundation, another non-FR component of a sleeping system, a FR mattress, a FR foundation, a FR mattress supported by a FR foundation and/or another FR component of a sleeping system, or a combination of one or more non-FR mattresses, non-FR foundations, other non-FR components of a sleeping system, FR mattresses, FR foundations and/or other FR components of a sleeping system not specifically recited herein. Once inserted through the opening 143 and into the interior volume of the protective FR component 140, the full enclosure of the mattress 142 within the protective FR component 140 is completed by closing the opening 143. For example, the sidewall 141 may have one or more straps 145 configured for removable engagement with a top wall 144 of the protective FR component 140.

Conversely, to partially enclose a non-FR mattress using a protective FR component similarly configured to the protective FR components 100″, 100′″ illustrated in FIGS. 2C and 2D, respectively, the protective FR component must be provided with a structure configured to secure the protective FR component to the component or components of the sleeping system to be protected thereby. A protective FR component equipped in this manner may be seen by reference to FIG. 3C. As may now be seen, one manner by which a protective FR component partially encloses one or more components of a sleeping system, bears some similarity to the techniques used to attach a mattress pad and/or fitted sheet to a mattress or to attach a bed skirt to a foundation. More specifically, FIG. 3C shows a protective FR component 150 partially enclosing a non-FR mattress 152. As may now be seen, the protective FR component 150 includes a top wall 150a, a first sidewall 150b, a second sidewall 150c, a third sidewall 150d and a fourth sidewall (not visible in FIG. 3C) which collectively partially enclose the non-FR mattress 152. Each of the first, second and third sidewalls 150b, 150c and 150d (as well as the fourth sidewall not visible in FIG. 3C) include elasticized ends portions, extending along the periphery thereof, which are pulled over a bottom side surface 152d of the non-FR mattress 150 and subsequently released such that they engage the bottom side surface 152d, thereby removably securing the protective FR component 150 to the non-FR mattress 152. As before, while FIG. 3C illustrates a non-FR mattress 152 being partially enclosed by the protective FR component 150, it is fully contemplated that the protective FR component 150 may instead partially enclose a non-FR foundation, a non-FR mattress supported by a non-FR foundation, another non-FR component of a sleeping system, a FR mattress, a FR foundation, a FR mattress supported by a FR foundation, and/or another FR component of a sleeping system, or a combination of one or more non-FR mattresses, non-FR foundations, other non-FR components of a sleeping system, FR mattresses, FR foundations and/or other FR components of a sleeping system or a combination of one or more non-FR mattresses, non-FR foundations, other non-FR components of a sleeping system, FR mattresses, FR foundations and/or other FR components of a sleeping system not specifically recited herein.

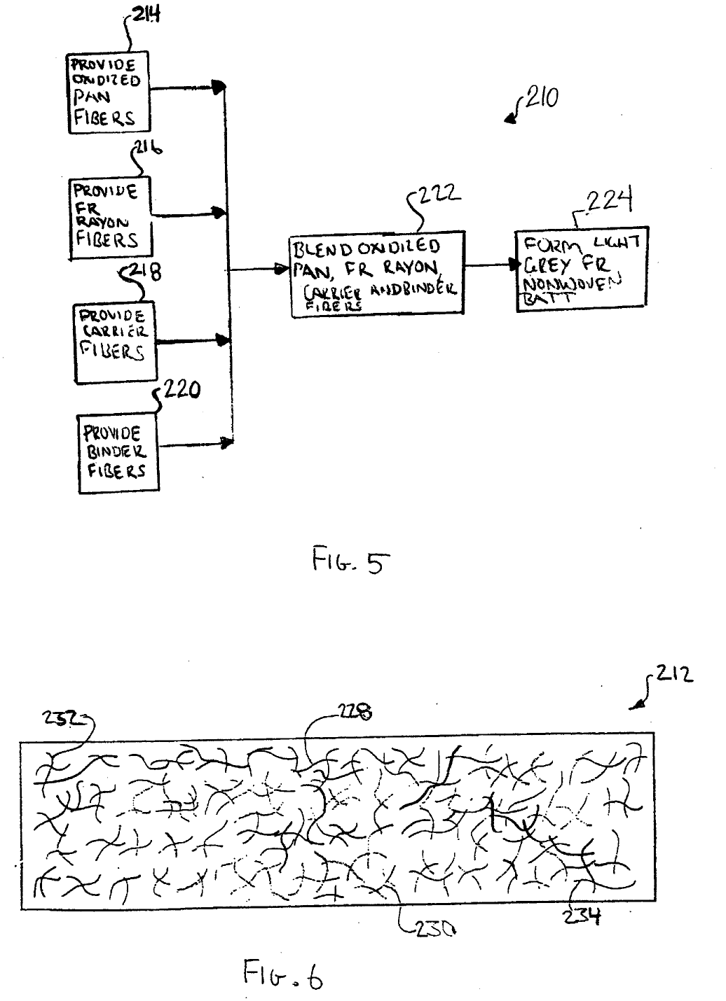

Referring next to FIG. 4, a protective FR component will now be described in greater detail. As will now be appreciated, while the protective FR components 100, 100′, 100″ and 100′″ described with respect to FIGS. 2A-D and 3A-C are characterized by varied shapes and/or dimensions relative to one another that enable respective ones of the protective FR components 100, 100′, 100″ and 100′″ to fully or partially enclose one or more components of a sleeping system 10 by application of a variety of techniques, it is contemplated that the internal structure of each one of the protective FR components 100, 100′, 100″ and 100′″ may be similarly constructed. More specifically, in an embodiment each of the protective FR components 100, 100′, 100″ and 100′″ includes a top cover 102, a FR layer 104, and a backing 106. The top cover 102, the FR layer 104, and the backing 106 are fixedly secured to one another, for example, using a suitable lamination process, such that a lower side surface 102b of the top cover 102 is disposed on, and fixedly secured to, an upper side surface 104a of the FR layer 104 and a lower side surface 104b of the FR layer 104 is disposed on, and fixedly secured to, an upper side surface 106a of the backing 106. In an embodiment, the top cover 102, the FR layer 104 and the backing 106 are quilted together using a conventional quilting process. Of course, use of the top cover 102 and the backing 106 are optional and, if desired, the FR layer 104 alone may form the protective FR components 100, 100′, 100″ and 100′″.

In addition to enhancing the FR characteristic of the combination of the protective FR component 100, 100′, 100″, 100′″ and a mattress, foundation, other component of a sleeping system or combination thereof, preferably to the extent necessary to render the combination FR, by quilting the top cover 102, the FR layer 104 and the backing 106 of the protective FR component 100, 100′, 100″ or 100′″ together, it is contemplated that the aesthetics of the protective FR components 100, 100′, 100″, 100′″ will be sufficiently enhanced such that it is more readily acceptable to those consumers who own sleeping systems with non-FR components that are unwilling to make any modifications that would enhance the safety of the sleeping system if such modifications would make the sleeping system less aesthetically pleasing. More specifically, it is contemplated that the use of a quilting process to construct the protective FR component 100, 100′, 100″, 100′″ would result in the protective FR component 100, 100′, 100″, 100′″ more closely resembling a non-FR mattress pad or the top of a conventional mattress, thereby enabling the protective FR components 100, 100′, 100″ and 100′″ to be more readily accepted by those consumers particularly concerned with aesthetics. Variously, the improved aesthetics attributable to the protective FR components 100, 100′, 100″ and 100′″ may be a result of characteristics of the top cover 102, the FR layer 104 or both.

Furthermore, by constructing the protective FR component 100, 100′, 100″ or 100′″ such that the FR layer 104 is formed using one or more FR materials characterized by relatively high levels of comfort and/or resiliency, the protective FR components 100, 100′, 100″ and 100″ would be more readily acceptable to those consumers who own sleeping systems with non-FR components that are unwilling to make any modifications that would enhance the safety of the sleeping system if such modifications would make the sleeping system less comfortable. More specifically, it is contemplated that the use of such materials in the FR layer 104 would result in the consumer viewing use of the protective FR component 100, 100′, 100″, 100′″ more like the use of a non-FR mattress pad or a topper of a conventional mattress. As a result, use of the protective FR components 100, 100′, 100″ and 100′″ would not be viewed by consumers as solely enhancing the FR characteristic of the sleeping system, but also as enhancing the comfort of the sleeping system. As a result, the protective FR components 100, 100′, 100″ and 100′″ would be more readily accepted by those consumers particularly concerned with the comfort of their sleeping system.

As will be more fully described below, it is contemplated that a wide variety of FR materials may be used to form a structure which, when employed as the FR layer 104 of the protective FR component 100, 100′, 100″ or 100′″, would be sufficiently “comfortable” to be suitable for the uses contemplated herein. Oftentimes, the level of comfort associated with a structure is associated with the degree to which the structure is resilient. Generally, a resilient material is characterized by a relatively high amount of air per unit volume of the material. For example, some resilient materials have about 90% air per unit volume. As used herein, the term “resilient material” shall encompass any structure that will deform in response to a compressive force and is capable of returning to its original shape after removal of the compressive force. For example, if sufficiently FR, a high loft nonwoven polyester fiber batt and/or a structure formed of an open-celled polyurethane foam are both considered to be resilient structures suitable for the uses contemplated herein. Of course, the foregoing are provided purely by way of example and it is specifically contemplated that other nonwoven fiber batts, foams and/or combinations thereof that are sufficiently FR are also suitable for the uses contemplated herein. Of the nonwoven FR fiber batts, compact nonwoven FR fiber batts (typically characterized as having a height of between about ⅔ and about one times its basis weight) are typically preferred over densified nonwoven fiber batts (which are typically characterized as having a height less than about ⅔ times its basis weight) while high loft nonwoven fiber batts (typically characterized as having a height greater than its basis weight) are typically preferred over both compact and densified nonwoven fiber batts. As used herein, the term “basis weight” refers to the weight in ounces of a square foot of the nonwoven fiber batt. Of the FR foams, those FR foams having an indentation load deflection (ILD) between about 15 and about 55 and/or a density between about 2.9 and about 3.2 pounds per cubic foot are generally preferred. Of course, other considerations may affect the selection of either a densified nonwoven FR fiber batt, a compact nonwoven FR fiber batt, a high loft nonwoven FR fiber batt or a FR foam having a specified ILD. For example, the desired degree of FR enhancement, the desired level of comfort enhancement and/or size limitations on the FR layer 104 and/or the protective FR component 100, 100′, 100″ or 100′″ may all affect the selection process.

Rather than using a quilting process to attach the top cover 102, the FR layer 104 and the backing 106 to one another, in a first alternative securement process, it is contemplated that the top cover 102, the FR layer 104, and the backing 106 may be attached to one another using an adhesive material. For example, a two-step lamination process in which a first spraying of an adhesive onto the upper side surface 106a of the backing 106 followed by a mounting, under heat and pressure, of the lower side surface 104b of the FR layer 104 onto the upper side surface 106a of the backing 106 and a subsequent second spraying of the adhesive onto the upper side surface 104a of the FR layer 104 followed by a mounting, under heat and pressure, of the lower side surface 102b of the top cover 102 onto the upper side surface 104a of the FR layer 104. After the top cover 102, the FR layer 104, and the backing 106 are laminated together in the manner described herein, the laminated combination passes through a pair of nip rollers to assure complete contact between the three layers.

In a second alternative securement process suitable for use if the FR layer contains either foam or bicomponent fibers, it is contemplated that the top cover 102 and/or the backing 106 may be laminated onto the FR layer 104 without an adhesive and subsequently secured, to the FR layer 104, during an associated curing process. Rather than employing one specified technique to secure the top cover 102, the FR layer 104 and the backing 106 in the configuration illustrated in FIG. 4, it is also contemplated that the protective FR components 100, 100′, 100″ and 100′″ may instead use a securement process comprised of a combination of the quilting, adhering and curing processes hereinabove described. Of course, it is fully contemplated that a variety of securement techniques other than the particular securement techniques described and illustrated herein will also be suitable for the purposes disclosed herein.

Continuing to refer to FIG. 4, the uppermost layer in the protective FR components 100, 100′, 100″ and 100′″ is the top cover 102. The top cover 102 may be a woven fabric or a nonwoven fiber batt. The fibers used in the top cover 102 may be natural fibers, such as cotton, silk, or wool, or a blend of different natural fibers. The fibers used in the top cover 102 may also be synthetic fibers, such as polyester, rayon, nylon, or polypropylene, or a blend of different synthetic fibers. The fibers used in the top cover 102 may also be a blend of natural and synthetic fibers. As the top cover 102 is the layer most likely to be visible to consumers of the protective FR components 100, 100′, 100″ and 100′″, it may be desirable for the top cover 102 to have an aesthetically pleasing appearance. In an alternate configuration, it is contemplated that the fibers used to construct the top cover 102 may contain a plurality of FR fibers, such as charring fibers, modacrylic fibers, or durable or non-durable chemically treated fibers. However, as such fibers are often dark in color or otherwise have an unattractive appearance, the use of such fibers may be disfavored despite the enhanced FR characteristic that would result from their incorporation into the protective FR components 100, 100′, 100″, 100′″. Ideally, therefore, the top cover 102 would be both aesthetically pleasing and FR. For example, such a top cover 102 may be formed from a blend of FR treated natural and synthetic fibers, for example, FR cotton and FR polyester. Of course, it is fully contemplated that the top cover 102 of the protective FR components 100, 100′, 100″ and 100′″ may be constructed using suitable materials other than those described herein.

The second layer in the protective FR component 100 is the FR layer 104, which may be an FR nonwoven fiber batt, an FR foam, or an FR coated fabric. In one embodiment, the FR layer 104 is a nonwoven fiber batt comprising a plurality of FR fibers, such as charring fibers. Charring fibers char when burned, thus forming a non-flammable physical barrier between the fire and the unburned material. Charring fibers may be oxidized to improve the FR properties of the fiber. Examples of suitable charring fibers are: polyacrylonitrile (PAN); oxidized polyacrylonitrile (O-PAN) such as PYRON® available from Zoltek Corporation of St. Louis, Mo.; aramids, including para-aramids (poly(p-phenylene terephthalamide), such as KEVLAR® available from E.I. duPont de Nemours and Company of Wilmington, Del., TWARON® available from Teijin Twaron BV of Arhem, the Netherlands, and meta-aramids (poly(m-phenylene isophthalamide), such as Nomex® available from DuPont; melamines such as BASOFIL® available from BASF Corporation of Florham Park, N.J.; polybenzimidazole (PBI); and novoloids, such as KYNOL® available from American Kynol, Incorporated of Pleasantville, N.Y. Another example of a charring fiber is a modacrylic fiber, which is a manufactured fiber wherein the fiber-forming substance is any long-chain synthetic polymer composed of less than 85 percent but at least 35 percent by weight acrylonitrile units. Examples of modacrylic fibers include: KANECERON® and PROTEX® available from Kaneka Corporation of Osaka, Japan and LUFNEN® available from Kanebo Goshen Limited of Tokyo, Japan. Still another example of a charring fiber is a carbonized fiber, such as carbon fibers. An example of a carbon fiber is PANEX® available from Zoltek.

In further embodiments, the FR fibers may instead be non-FR fibers that are treated with a FR chemical compound, most commonly, by either impregnating or coating the non-FR fibers with the FR chemical compound. Variously, the FR chemical compound may be wash durable or non-wash durable. Examples of wash durable FR chemical compounds suitable for the uses contemplated herein include the X-12 chemical compound manufactured by DuPont, the GUARDIAN series of specialty flame retardancy chemical compounds manufactured by Glo-Tex International, Inc. of Spartanburg, S.C. and the FR chemical compound disclosed in U.S. Pat. No. 3,997,699 entitled “Flame Resistant Substrates” and hereby incorporated by reference as if reproduced in its entirety. Another wash-durable fiber suitable for the purposes contemplated herein is a fiber commercially available under the name LENZING FR® and manufactured by Lenzing AG of Lenzing, Austria. Of course, while it is contemplated that the FR chemical compound used to treat the FR fibers may be non-wash durable, non-wash durable treatments are not preferred because they lose the FR effectiveness when washed. Finally, it is fully contemplated that any wash durable or non-wash durable fibers selected of the fibers described above may also be treated with other chemicals such as antimicrobial chemicals, antioxidants, or dyes to provide the benefits commonly associated which such chemical treatments.

In still further embodiments thereof, it is contemplated that the FR fibers to be blended with the carrier fibers, typically, the aforementioned polyester carrier fibers and binder fibers, typically, the aforementioned polyester binder fibers characterized by a melting point lower than the polyester carrier fibers, may be an inherently FR fiber that neither melts nor flows when in contact with heat or flame, preferably an inherently FR hybrid fiber, e.g., fibers that are part-organic and part-inorganic. A part-organic and part-inorganic hybrid fiber suitable for the purposes contemplated herein would be a viscose staple fiber containing silicic acid. Such a fiber may be formed by blending a cellulosic fiber and a polysilic acid, for example, silicon dioxide. The blend may also be modified by an aluminum compound, for example, sodium aluminate, so that the resultant hybrid fiber includes aluminum silicate sites. Fibers satisfying the foregoing requirements are currently sold by Sateri Oy of Valkeakoski, Finland under the trade name VISIL® and are described in greater detail in U.S. Pat. No. 5,417,752, which is hereby incorporated by reference as if reproduced in its entirety.

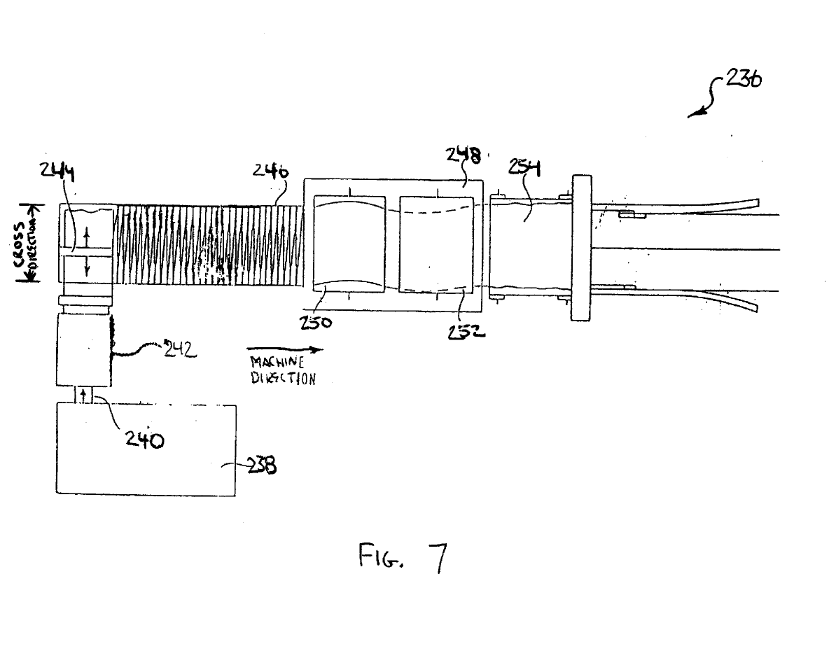

Generally, the process of forming the FR fibers into a FR fiber batt typically begins with a blending process in which a first plurality of a first type of FR fibers are blended with a second plurality of one or more other types of fibers which, as will be more fully described below with respect to FIGS. 5-7, may be FR fibers or non-FR fibers. The fiber blend is air-laid or carded into a web using a carding device. The web is then compressed and cured in an oven to form an FR fiber batt. The FR fiber batt is then cooled and trimmed to be ready for use as the FR layer 104 of the protective FR component 100, 100′, 100″ 100′″. The device used in the described process of forming a nonwoven FR fiber batt from a blend of one or more types of fibers shall be briefly described hereinbelow. It should be noted, however, that additional details of the disclosed process are set forth in U.S. patent application Ser. No. 10/968,318 filed Oct. 18, 2004, entitled “Method for Forming A Fire Combustion Modified Batt” and previously incorporated by reference.

The FR fibers may also be spun into a yarn and used to weave a woven fabric. The typical woven fabric is made by processing the FR fibers into a yarn. If desired, the FR fibers may be blended with natural or synthetic carrier fibers so that the yarn is a blend of FR fibers and carrier fibers. The yarn may then be used in the warp direction, the weft direction, or both. The yarn containing the FR fibers and, optionally, a second yarn if the yarn containing the FR fibers is not used in both directions, is woven into a fabric using a plain, a twill, or a satin weave. Alternatively, the fabric may be woven using a combination of the plain, twill, and satin weaves. Of course, it is fully contemplated that construction of the protective FR component 100, 100′, 100″, 100′″ may be accomplished using woven fabric production methods other than the woven fabric production methods described herein.

The third layer of the protective FR component 100, 100′, 100″, 100′″ is the backing 106. Variously, the backing 106 may be a woven fabric or a nonwoven fiber batt. The fibers used in the backing 106 may be natural fibers, such as cotton, silk, or wool, or a blend of different natural fibers. The fibers used in the backing 106 may also be synthetic fibers, such as polyester, rayon, nylon, or polypropylene, or a blend of different synthetic fibers. The fibers used in the backing 106 may also be a blend of natural and synthetic fibers. Optionally, the fibers used in the backing 106 may contain a plurality of FR fibers, such as charring fibers, modacrylic fibers, or durable or non-durable chemically treated fibers, as discussed above. Preferably, the backing 106 is a woven fabric consisting of a blend of natural and synthetic fibers, such as cotton and polyester.

Of course, it is fully contemplated that backings other than the particular backings described herein are suitable for use as part of the protective FR component 100, 100′, 100″, 100′″.

Thusfar, a multitude of configurations of the FR layer 104 of the protective FR component 100, 100′ 100″, 100′″ have been disclosed. It should be noted, however, that certain ones of these configurations are particularly well suited for use in enhancing the FR characteristic of a mattress, foundation, other component of a sleeping system, combination of components of a sleeping system, component of another type of composite furniture system or components of another type of composite furniture system by fully or partially enclosing the mattress, foundation, other component of a sleeping system, combination of components of a sleeping system, component of another type of composite furniture system or components of another type of composite furniture system. For example, while the inclusion of FR fibers (in any one of a variety of forms), is suitable for use as a component of the FR layer 104, an FR nonwoven fiber batt is particularly well suited for the disclosed applications. It is noted that there is a wide variety of fiber blends suitable for use in forming the FR nonwoven fiber batt and it is specifically contemplated that the FR nonwoven fiber batt may be formed using any of such fiber blend.

It is further noted, however, that a number of factors may be used when to evaluate, relative to one another, the various fiber blends suitable for forming the FR nonwoven fiber batt. These factors include relative FR, color and price. In this regard, the fiber blend having the greatest resistance to flame, e.g., the fiber blend that bums at the slowest rate in the presence of a external source of ignition, for example, a flame, and/or is more likely to extinguish itself after the external source of ignition is removed, the lightest color and the lowest cost per unit volume would be the preferred fiber blend with which to form the FR nonwoven fiber batt.

For example, fiber blends which include O-PAN tend to be more FR than those without O-PAN. In spite of this, fiber blends which include greater amounts of O-PAN are characterized by a number of disadvantages, among them, a greater difficulty in forming a batt, particularly, a high loft batt. Typically, high loft batts tend to be more comfortable than densified batts and, as more comfortable sleeping systems are generally favored over less comfortable ones, fiber blends which better lend themselves to the formation of high loft batts would be favored over fiber blends which better lend themselves to the formation of denser batts. Another disadvantage associated with the use of O-PAN in fiber blends relate to the color of O-PAN. As is well known in the art, O-PAN is black. As a result, fiber blends comprised of greater amounts of O-PAN tend to be darker in color than fiber blends having lesser amounts of O-PAN. Generally, lighter FR nonwoven batts are favored, particularly in sleeping system applications where visual aesthetics are important. As a protective FR component, for example, the protective FR component 100, 100′, 100″ or 100′″, partially or fully encloses a mattress, foundation or other component of a sleeping system, the use of darker fiber blends are generally disfavored because the darker FR nonwoven fiber batts tend to make the component of the sleeping system partially or fully enclosed thereby less aesthetically pleasing. An example in which plural FR fiber blends are evaluated to identify the most suitable blend for use in forming an FR nonwoven fiber batt is set forth in co-pending Nonprovisional U.S. patent application Ser. No. 11/088,658, filed Mar. 23, 2005, entitled “Gray Fire Resistant Nonwoven Batt formed from a Blend of Fire Retardant Materials and an Associated Method of Manufacturing the Same” and previously incorporated by reference.

Weighing these and other considerations, a number of fiber blends have been identified as suitable fiber blends for use in forming the FR nonwoven fiber batt which serves as the FR layer 104. One such fiber blend with which the FR nonwoven fiber batt may be formed is a blend of about 25% by volume generally black O-PAN fibers, about 25% by volume generally white FR Rayon fibers and about 50% by volume generally white polyester carrier fibers. While it is further contemplated that the foregoing blend may be formed into a FR nonwoven fiber batt using either low-melt or resin bonding, as high loft FR nonwoven fiber batts generally characterized by a higher degree of comfort are typically preferred in sleeping system applications and as high loft FR nonwoven fiber batts are commonly formed using binder fibers, it is still further preferred that the 50% by volume polyester carrier fiber be comprised of about 20% by volume of a generally white low-melt polyester binder fiber and about 30% by volume of a generally white dry polyester. Of course, it is fully contemplated that resin bonded FR nonwoven fiber batts are also suitable for the purposes disclosed herein.

Each of the protective FR components 100, 100′, 100″ and 100′″ is comprised of a section of material arranged in a specified shape. As was seen in FIGS. 2A, 2B, 2C and 2D, the section of material used to form respective ones of the protective FR components 100, 100′, 100″ and 100′″ is either shaped and/or sized differently that the other ones of the protective FR components 100, 100′, 100″ and 100′″. By doing so, each one of the protective FR components 100, 100′, 100″ and 100′″ are configured to fully or partially enclose different components of a sleeping system and/or partially enclose different portions of various components of a sleeping system. For example, the protective FR component 100 employs a first section of a specified material to fully enclose a first component of a sleeping system and a second section of the specified material to fully enclose a second component of the sleeping system. The protective FR component 100′ fully encloses first and second components of a sleeping system using a single section of the specified material. The protective FR component 100″ partially encloses a first component of a sleeping system using a single section of the specified material. Finally, the protective FR component 100′″ partially encloses first and second components of a sleeping system using a single section of the specified material.

While the different protective FR components 100, 100′, 100″, 100′″ disclosed herein are configured differently, the protective FR components 100, 100′, 100″, 100′″ share a common feature, specifically, the use of a common material to form the sections of each of the protective FR components 100, 100′, 100″, 100′″. As was previously described with respect to FIG. 4, the cross section of the section of material from which the various protective FR components 100, 100′, 100″, 100′″ are constructed is comprised of a backing 102, a cover member 106 and a FR layer 104 positioned between the backing 102 and the cover member 106. After being arranged in the illustrated manner, the backing 102, FR layer 104 and cover member 106 are preferably quilted together to complete assembly of the section of material.

It was further disclosed that, in certain embodiments thereof, the FR layer 104 is comprised of a nonwoven FR fiber batt formed from a fiber blend which variously included charring fibers, O-PAN fibers, FR Rayon fibers, modacrylic fibers, polyester low-melt binder fibers and polyester dry fibers. Thusfar, a number of the possible fiber blends have been disclosed. However, details as to the various processes which may be used to form the FR nonwoven fiber batts and specific characteristics of the FR nonwoven fiber batts resulting from use of the fiber blend have yet to be disclosed.

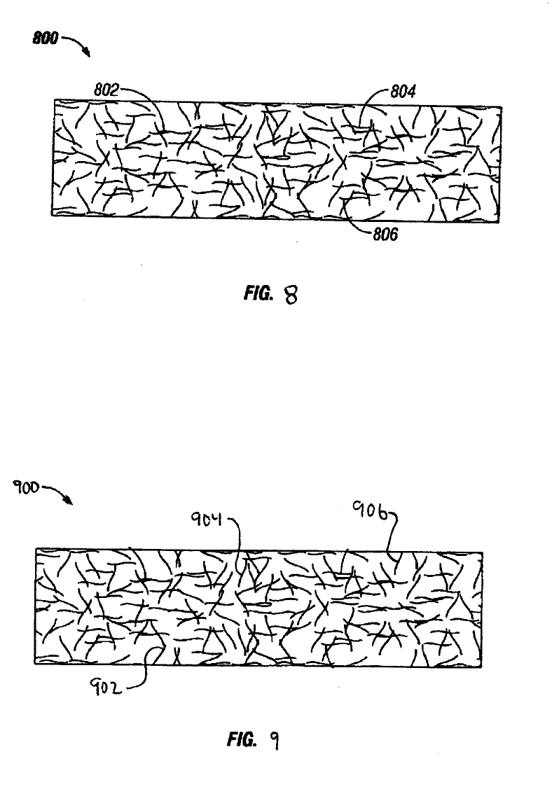

Referring now to FIG. 5, a process 210 by which one embodiment of a FR nonwoven batt 212 constructed in accordance with the teachings of the present invention will now be described in greater detail. The process 210 commences by providing a first quantity of a first type of fiber at 214. Similarly, a second quantity of a second type of fiber is provided at 216, a third quantity of a third type of fiber is provided at 218, and a fourth quantity of a fourth type of fiber is provided at 220. After the specified quantities of the first, second, third and fourth fibers have been provided at 214, 216, 218 and 220, respectively, the method proceeds to 222 where the provided quantities of the first, second, third and fourth types of fibers are blended together to form a first blend of plural fiber types. Alternatively, a greater or lesser number of types of fibers may be blended to produce various embodiments of FR batts, such as the FR batts herein below described with respect to FIGS. 8 and 9.

While there may be any number of different classes, groups and/or types of black FR fibers suitable for selection as the first class and/or type of FR fiber, one class of fibers which are suitable in FR applications are generally known as charring fibers. Within the charring class of fibers, a suitable subclass of fibers are generally known as carbon fibers. Of course, the foregoing are identified purely by way of example and it is fully contemplated that a wide variety of other FR fibers are equally suitable for the purposes contemplated herein. In a specific embodiment of the invention, it is contemplated that the first type of fibers provided at step 214 for inclusion in the first blend of plural fiber types be comprised of an O-PAN fiber currently marketed by Zoltek Corporation of St. Louis, Mo. under the product name Pyron®. The Pyron® fiber is an O-PAN fiber having a carbon level of 62% which is produced from an acrylic precursor that has been stabilized by a continuous oxidation process that converts the PAN from a thermoplastic state to a thermoset state. Of course, O-PAN formed from an acrylic precursor having a composition which differs from the composition of the acrylic precursor used to form to form Pyron®, as well as O-PAN formed to have a having carbon level other than the 62% carbon level of Pyron®, would also be suitable for use as the first type of fibers provide at step 214 for inclusion in the first blend of plural fiber types. Generally, the physical characteristics of O-PAN fibers are its black color, moisture content of about 4 to 9 percent, average fiber diameter of about 11 to 14 microns, fiber tensile strength of about 180 to 300 Mpa, fiber elongation of about 18 to 28 percent, fiber density of about 1.36 to 1.38 g/cc and fiber length of about 4 to 15 cm. In addition, in the case of Pyron®, the O-PAN fibers are thermally stable up to 600° F.

In its broadest sense, the second type of fiber provided at 216 for inclusion in the first blend of plural fiber types is any FR fiber of a white or sufficiently light color capable of rendering the FR fiber blend sufficiently white for use in certain FR bedding, FR upholstery and any number of other FR applications where a white or relatively light colored FR nonwoven fiber batt is greatly preferred. While there may be any number of different classes, groups and/or types of white FR fibers suitable for selection as the class and/or type of FR fiber, one class of fibers which include a number of white or light fibers suitable for use in FR applications where a white or relatively light FR nonwoven fiber batt is preferred are white inherently FR fibers. Similarly, a group of white inherently FR fibers which include a number of white or light fibers suitable for use in FR applications where a white or relatively light FR nonwoven fiber batt is preferred are white cellulosic fibers.

Of course, the foregoing should not be interpreted as limiting the scope of the invention to either the group of fibers known as white cellulosic fibers or the class of fibers known as white inherently FR fibers. Rather, when the present disclosure speaks of either white cellulosic fibers and/or white inherently FR fibers, it should be clearly understood that the present disclosure is equally applicable to any class, group and/or type of FR fiber generally acknowledged in the art to be white in color. Nor is it intended that the teachings of the invention be limited to white fibers. Rather, in recognition that many light colored FR fibers will be suitable in certain FR bedding, FR upholstery and any number of other FR applications where a white or relatively light colored FR nonwoven fiber batt is greatly preferred, it is fully contemplated that the techniques disclosed herein may be applied to other classes, groups or types of FR fibers generally recognized as having a relatively light color.

Thus, as previously set forth, the second type of fiber provided at 216 for inclusion in the first blend of plural fiber types may be any FR fiber of a white or sufficiently light color which would render the FR fiber particularly well suited for use in the very FR applications for which the first type of FR fiber is unsuited, e.g., those FR applications in which the aesthetics of the final product necessitate that the FR fiber batt have either a white or light coloring. In various embodiments thereof, it is contemplated that the second type of fiber provided at 216 for inclusion in the first blend of plural fiber types may be any white FR fiber. As further previously set forth, while there may be any number of different types white FR fibers suitable for selection as the second type of FR fiber, one type of white FR fiber suitable for use in FR applications where a white or relatively light colored FR batt is required is a white FR treated cellulosic fiber such as FR treated rayon fiber or FR treated cotton fiber. Of these, the type of FR treated cellulosic fiber preferred for use as the white FR fiber is FR treated rayon fiber.

In its broadest sense, the third type of fiber provided at 218 for inclusion in the first blend of plural fiber types is a white carrier fiber. In alternate embodiments thereof, the carrier fiber may either be an FR white carrier fiber or a non-FR white carrier fiber. While it is appreciated that the use of a white carrier fiber that it also characterized as a FR fiber would provide a number of benefits over non-FR carrier fibers, it is equally appreciated that there are a number of considerations that provide strong motivation for the use of white non-FR fibers over white FR fibers as the carrier fiber for the nonwoven FR fiber batt disclosed herein. One such consideration is cost. Generally, non-FR fibers tend to cost less than FR fibers and, if the FR characteristic of the resultant nonwoven fiber batt meets a selected flammability standard, the use of additional FR fibers would represent an unnecessarily costly, over-engineered nonwoven fiber batt. Furthermore, comfort, loft and durability are equally important, if not overriding, consideration in forming the FR nonwoven fiber batt, particularly when the FR nonwoven fiber batt is used in bedding and upholstered product applications. In this regard, nonwoven fiber batts in general, and high loft nonwoven fiber batts in particular, are more easily formed used non-FR fibers and the resultant nonwoven fiber batts are typically more comfortable and durable than those formed using FR fibers. Accordingly, upon weighing the various considerations, the use of a non-FR white fiber as the carrier fiber is best suited for the purposes contemplated herein. Of the various white carrier fibers that are generally characterized as non-FR, those non-FR carrier fibers that tend to melt and drip when exposed to a flame or other source of ignition are generally preferred over those carrier fibers that would tend to burn when exposed to a flame.

It is further contemplated that the non-FR white carrier fiber may either be a non-FR white natural carrier fiber or a non-FR white synthetic carrier fiber. Of the foregoing, non-FR white plastic polymer fibers such as polyester are suitable non-FR white synthetic carrier fibers. Of course, other fibers can be used depending upon the precise processing limitations imposed and the characteristics of the FR nonwoven fiber batt 212 which is desired at the end of the process 210. As disclosed herein, non-FR white carrier fibers as a class of fibers, non-FR white synthetic carrier fibers as a group of fibers and non-FR white polyester fibers as a type of fiber are well suited for the purposes contemplated herein. This presumes, of course, that the disclosed class, group and type of fibers are white fibers. For example, polyester type synthetic carrier fiber is recognized as a white fiber. Accordingly, a dry polyester fiber is the preferred carrier fiber for use in constructing the nonwoven FR fiber batt 212.

For purposes of illustrating the process 210 and the FR nonwoven batt 212 produced thereby, a dry polyester carrier fiber suitable for use as the third type of fiber to be provided at step 218 for inclusion in the first blend of plural fiber types is a Type 209 fiber manufactured by KoSa of Houston, Tex. The Type 209 KoSa fiber is a 6 to 15 denier, round hollow cross section white polyester fiber having a length which varies from 2 to 3 inches. A second type of polyester carrier fiber suitable for use as the third type of fiber to be provided at step 218 for inclusion in the first blend of plural fiber types is a Type 295 fiber, also manufactured by KoSa. The Type 295 KoSa fiber is a 6 to 15 denier, pentalobal cross section white polyester fiber having a length which varies from ⅕ to 4 inches in length. However, it is fully contemplated that other white or light colored nonwoven carrier fibers are also suitable for use as the third type of fiber to be provided at step 218 for inclusion in the first blend of plural fiber types.

The fourth type of fiber provided at 220 for inclusion in the first blend of plural fiber types is a binder fiber. While any number of different types of binder fibers are suitable of inclusion in the first blend of plural fiber types, one suitable binder fiber is a white low-melt polyester fiber. As previously set forth in the “Notation and Nomenclature” section of the present disclosure, as used herein, the term “low-melt” is intended to describe the relative melting points of the carrier and binder fibers, specifically, that the binder fiber has a relatively low predetermined melting temperature when compared to that of the other types of fibers in the blend. Thus, the term “melting” does not necessarily refer only to the actual transformation of the solid polyester binder fibers into liquid form. Rather, it also refers to a gradual transformation of the fibers or, in the case of a bicomponent sheath/core fiber, the sheath of the fiber, over a range of temperatures within which the polyester becomes sufficiently soft and tacky to cling to other fibers with which it comes in contact, including other binder fibers having its same characteristics and, as described above, adjacent white polyester carrier fibers, white FR rayon fibers and black FR O-PAN fibers, all of which have a higher melting temperature. For purposes of illustrating the process 210 and nonwoven FR fiber batt 212 and not by way of limitation, a binder fiber suitable for use as the fourth type of fiber to be provided at 220 for inclusion in the first blend of plural fiber types is Type 254 Celbond® fiber manufactured by KoSa. The Type 254 Celbond® fiber is a bicomponent fiber with a polyester core and a copolyester sheath. The sheath component melting temperature is approximately 230° F. (110° C.). Of course, rather than the bicomponent fiber disclosed herein, it is contemplated that a polyester copolymer may instead be the fourth type of fiber provided at step 220 for inclusion in the first blend of plural fiber types.

Proceeding on to 222, once the black FR, preferably, O-PAN fiber, the white FR fiber, preferably FR rayon fiber, the white carrier fiber, preferably, dry polyester fiber and the white binder fiber, preferably, low-melt polyester fiber, are provided in the proportional amounts to be more fully described below, the black FR, white FR, white carrier and white low-melt fibers are blended together. Once the blend of the plural fiber types, preferably, a blend of black FR O-PAN fiber, white FR rayon fiber, white dry polyester carrier fiber and white polyester binder fiber, is formed, the method proceeds to 224 where a nonwoven FR fiber batt 212 is formed by the application of temperature and pressure to the blend of plural fiber types by selected components of the processing line to be more fully described below.

Referring next to FIG. 6, the nonwoven FR fiber batt 212 formed from the first blend of plural types of fibers will now be described in greater detail. As may now be seen, the nonwoven FR fiber batt 212 is composed of a blend of black FR O-PAN fibers 228, white FR rayon fibers 230, white dry polyester carrier fibers 232 and white low-melt polyester binder fibers 234 that adhere to one another and to the black FR O-PAN fibers 228, the white FR rayon fibers 230 and the white dry polyester carrier fibers 232. The black FR O-PAN fibers 228 and the white FR rayon fibers 230 provide the nonwoven FR fiber batt 212 with protection against burning. The white dry polyester carrier fibers 232 provide additional comfort and aesthetics to the nonwoven FR nonwoven batt 212 but fail to provide any additional protection against burning. By blending the aforementioned types of fibers, the resultant light gray FR nonwoven batt 212 has a lighter color when compared to other FR nonwoven fiber batts such as the dark gray FR nonwoven fiber batt disclosed in International Publication No. WO 01/68341 A1 published Sep. 20, 2003 and hereby incorporated by reference as if reproduced in its entirety. By lightening the color thereof, the resultant light gray FR nonwoven fiber batt 212 will be easily recognized as having improved aesthetics in addition to improved suitability in applications requiring white or light FR materials relative to a dark gray FR nonwoven fiber batt.

The first blend of plural fiber types can be any one of a number of suitable blends. In one embodiment, the binder fiber can be anywhere in the range of about 5 percent to about 50 percent by volume of the blend. The relative percent volume of the combined black FR O-PAN fibers and the white FR rayon fibers to the white polyester carrier fibers in the remaining volume may range anywhere from about 15 percent black FR O-PAN/85 percent white FR rayon to about 85 percent black FR O-PAN/15 percent white FR rayon. In a preferred embodiment, the ratio of the relative volume of the combined black O PAN fibers and the white FR rayon fibers to the white polyester carrier fibers in the remaining volume is roughly 1:1, i.e., the remaining volume is roughly 50 percent combined black FR O-PAN fibers and 50 percent white FR rayon fibers and 50 percent white polyester carrier fibers. In an even more preferred embodiment, the ratio of the relative volume of the black FR O-PAN fibers and the white FR rayon fibers in the combined black FR O-PAN fibers and white FR rayon fibers is about 1:1, i.e., the combined black FR O-PAN fibers and white FR rayon fibers is roughly 50 percent black FR O-PAN fibers and roughly 50% white FR rayon fibers. Thus, for a blend having about 10 percent by volume of binder fibers, a roughly fifty to fifty percent relative volume of combined black FR O-PAN fibers and the white FR rayon fibers to the white dry polyester carrier fibers and a roughly fifty to fifty percent relative volume of the black FR O-PAN fibers to the white FR rayon fibers, the volume of white low-melt polyester binder fibers is about 10 percent, the volume of black FR O-PAN fibers is about 22.5 percent, the volume of white FR rayon fibers is about 22.5 percent and the volume of white polyester carrier fibers is about 45 percent.

Of course, the selection of the relative volumes of the black FR O-PAN fibers, white FR rayon fibers, white dry polyester carrier fibers and white low-melt polyester binder fibers used to form the first blend of plural fiber types would have other effects on the characteristics of the resultant nonwoven FR fiber batt 212. Other characteristics which would be affected by the particular blend selected would include: (1) the FR characteristic of the nonwoven FR fiber batt 212; and (2) the cost of the nonwoven FR fiber batt 212. It should be further appreciated that, in addition to providing a FR nonwoven fiber batt having the best possible combination of aesthetics and FR protection, another goal of a FR nonwoven fiber batt manufacturer would be to minimize the costs incurred while manufacturing the FR nonwoven fiber batt.

Referring now to FIG. 7, a schematic top plan view of the general processing line 236 for constructing the nonwoven FR fiber batt 212 will now be described in greater detail. The black FR O-PAN fibers, the white FR rayon fibers, the white polyester carrier fibers and the white low-melt polyester fibers are blended in a fiber blender 238 and conveyed by a conveyor pipe 240 to a web forming machine 242. A suitable web forming machine is a garnett machine. An air laying machine, known in the trade as a Rando webber, or any other suitable apparatus can also be used to form a web structure. The garnett machines 242 cards the blended fibers into a nonwoven web having a desired width and deliver the web to cross-lapper 244. There, the nonwoven web is cross-lapped onto a slat conveyor 46 which is moving in the indicated machine direction. The conveyor 246 then transports the web to housing 248 for thermal bonding thereof. While there are a variety of thermal bonding methods which are suitable for the purposes contemplated herein, one such method comprises using vacuum pressure applied through perforations (not shown) in first and second counter rotating drums 250 and 252 positioned in a central portion of the housing 248 and heating the web to the extent necessary such that the relatively low melting temperature binder fibers in the web fuse the low melt binder fibers together and to the white polyester carrier fibers, the white FR rayon fibers and the black FR O-PAN fibers of the web. Alternatively, the web may instead move through an oven by substantially parallel perforated or mesh wire aprons to melt the low temperature binder fibers.

As it exits the housing 248, the web is compressed and cooled by a pair of substantially parallel wire mesh aprons 254, only one of which is visible in FIG. 7. The aprons 254 are mounted for parallel movement relative to each other to facilitate adjustment for a wide range of web thicknesses. The web can be cooled slowly through exposure to ambient temperature air or, in the alternative, ambient temperature air can forced through the perforations of one apron 254, through the web and through the perforations of the other apron 254 to cool the web and set it in its compressed state. The web is maintained in its compressed form upon cooling since the solidification of the low-melt polyester binder fibers in their compressed state bonds the fibers together in that state.

An alternate embodiment of a FR nonwoven fiber batt 800 suitable for use as the FR layer 104 of the protective FR component 100, 100′, 100″, 100′″ will now be described in greater detail. As may now be seen in FIG. 8, the FR nonwoven fiber batt 800 is formed from a blend of charring fibers 802, oxygen depleting fibers 804 and nonwoven fibers 806. In various embodiments of the FR nonwoven fiber batt 800, it is contemplated that the charring fibers 802 may be a fire resistant treated cellulosic charring fibers such as FR treated rayon fibers and the oxygen depleting fibers 804 may be Protex® modacrylic fibers manufactured by Kankeka Corporation of Osaka, Japan, other modacrylic fibers or other suitable oxygen depleting fibers. It is further contemplated that the nonwoven fibers 806 may be comprised entirely of carrier fibers, comprised entirely of binder fibers or comprised of a blend of carrier fibers and binder fibers. Of the foregoing, however, it is preferred that the nonwoven fibers 806 be comprised entirely of binder fibers. In a preferred embodiment thereof, the FR nonwoven fiber batt 800 is comprised of about sixty percent, by volume, of FR treated rayon fibers 802, about twenty percent, by volume, of modacrylic fibers 804 such as the aforementioned Protex® modacrylic fibers and about twenty percent, by volume, of a low-melt binder fiber 806. When formed in accordance with the foregoing, the uni-layer FR nonwoven fiber batt 800 would have a basis weight of about ¾ oz. per sq. ft.

Of course, as this, the preferred embodiment of the FR nonwoven fiber batt 800 includes low melt binder fibers, the aforedescribed thermal bonding processing would be better suited for use during the formation thereof. In this regard, while it is fully contemplated that the aforedescribed resin bonding processes may instead be used during the formation process, the resultant FR nonwoven batt formed using resin bonding processes would tend to be less fire resistant than those formed using thermal bonding processes.

It should also be fully understood that the disclosure of a preferred embodiment of the FR nonwoven batt 800 as being comprised of about sixty percent, by volume, of the charring fibers 802, about twenty percent, by volume, of the oxygen-depleting fibers 804 and about twenty percent, by volume, of the binder fibers 806 should not be interpreted as suggesting that no other compositions of the charring and oxygen-depleting fibers would prove suitable for the purposes contemplated herein. Rather, it should be clearly understood that a wide variety of compositions are also suitable for the purposes contemplated herein.

More specifically, broadly speaking, it has been discovered that, to adequately delay breakthrough of the charring fibers 802, the fiber blend must be a minimum of about ten percent, by volume, of the mpdacrylic fibers 804. It has been further discovered that, to maintain the desired structural integrity of the FR nonwoven fiber batt 800, the fiber blend must be a minimum of about fifty percent, by volume, of the charring fiber 802. Thus, the percentage, by volume, of either the charring fibers 802 or the oxygen-depleting fibers 804 may be increased by a corresponding reduction in the percentage, by volume, of the binder fibers 806. For example, it is contemplated that the binder fibers 806 may be reduced to at least about twelve percent, by volume, of the fiber blend. Further, the percentage, by volume, of the oxygen-depleting fibers 804 may also be increased by a corresponding reduction in the percentage, by volume, of the charring fibers 802 from the aforementioned about sixty percent, by volume, to a desired volume at or above the minimum of about fifty percent, by volume, of the fiber blend while the percent, by volume, of the charring fibers 802 may also be increased by a corresponding reduction in the percent, by volume, of the oxygen-depleting fibers 804 from the aforementioned about twenty percent, by volume, to a desired volume at or above the minimum of about ten percent, by volume, of the fiber blend. Thus, the fiber blend from which the FR nonwoven fiber batt 800 may be comprised of between about fifty and about seventy-eight percent, by volume of the charring fibers 802, between about ten percent and about thirty-eight percent, by volume, of the oxygen-depleting fibers 804 and between about twelve percent and about forty percent, by volume, of the binder fibers 806.

While further variations of the percentages by volume of the charring fibers 802, the oxygen-depleting fibers 804 and the nonwoven fibers 806 beyond those specifically hereinabove recited are also contemplated, any such further variations should be made in conjunction with a modification of the basis weight of the FR nonwoven fiber batt 800. For example, the aforedescribed fiber blend comprised of about sixty percent, by volume, of the charring fibers 802, about twenty percent, by volume, of the oxygen-depleting fibers 804 and about twenty percent, by volume of the binder fibers 806 has a basis weight of 0.75 ounces per square foot which, in turn, can be broken down into component basis weights of 0.45 ounces per square foot of the charring fibers 802, 0.15 ounces per square foot of the oxygen-depleting fibers 804 and 0.15 ounces per square foot of the binder fibers 806. If the component basis of the oxygen-depleting fibers 804 were then increased to 0.40 ounces per square foot, the resultant FR nonwoven fiber batt 800 would have basis of 1.0 ounces per square foot comprised of a fiber blend of about forty-five percent, by volume of the charring fibers 802, about forty percent, by volume, of the oxygen-depleting fibers 804 and about fifteen percent, by volume, of the binder fibers 806. Thus, while it is possible to further modify the composition of the blend of the charring, oxygen-depleting and nonwoven fibers 802, 804 and 806, such modifications should be accompanied by a modification in the basis of the FR nonwoven fiber batt 800. In the example hereinabove described, while the percentage, by volume, of the oxygen-depleting fibers 804 was increased above the about ten percent to about thirty-eight percent, by volume, range previously described, such an increase was achieved by densifying the FR nonwoven fiber batt 800 beyond that originally contemplated.

By configuring a FR nonwoven fiber batt 800 in the manner described herein, an FR nonwoven fiber batt characterized by enhanced fire resistance performance, once-for-ounce, when compared to many existing fire resistant batt products, is produced. Further, because the disclosed FR nonwoven batt 800 can achieve similar fire resistance performance as existing fire resistant batts while remaining lighter, the disclosed FR nonwoven batt may be used to reduce manufacturing costs. More specifically, FR rayon is a fiber which chars when exposed to flame and also tends to self-extinguish. By robbing oxygen from the flame, the modacrylic fibers will tend to reduce the heat produced by the flame, slow the conversion of the FR rayon fibers into char and enhance the ability of the FR rayon fibers to self-extinguish As a result, the breakthrough of fire through the FR nonwoven batt 800 is slowed.

Another alternate embodiment of a FR nonwoven fiber batt 900 suitable for use as the FR layer 104 of the protective FR component 100, 100′, 100″, 100′″ will now be described in greater detail. As may now be seen in FIG. 8, the FR nonwoven fiber batt 900 is formed from a blend of oxidized polyacrylonitrile (O-PAN) fibers 902 and nonwoven fibers. The nonwoven fibers include carrier fibers 904 and binder fibers 906. The fibers can be natural or synthetic. For example, thermoplastic polymer fibers such as polyester are suitable synthetic fibers. Other fibers can be used depending upon the precise processing limitations imposed and the characteristics of the batt which are desired at the end of the process. For purposes of illustrating the process and combustion modified batt and not by way of limitation, the carrier fiber is KoSa Type 209, 6 to 15 denier, 2 to 3 inches in length, round hollow cross section polyester fiber. Alternatively, the carrier fiber is KoSa Type 295, 6 to 15 denier, ⅕ to 4 inches in length, pentalobal cross section polyester fiber. Other nonwoven fibers are suitable as carrier fibers for the present invention and are within the scope of this invention.

The binder fiber has a relatively low predetermined melting temperature as compared with the carrier fiber. As used herein, however, the term melting does not necessarily refer only to the actual transformation of the solid polyester binder fibers into liquid form. Rather, it refers to a gradual transformation of the fibers or, in the case of a bicomponent sheath/core fiber, the sheath of the fiber, over a range of temperatures within which the polyester becomes sufficiently soft and tacky to cling to other fibers within which it comes in contact, including other binder fibers having its same characteristics and, as described above, adjacent polyester fibers having a higher melting temperature. It is an inherent characteristic of thermoplastic fibers such as polyester that they become sticky and tacky when melted, as that term is used herein. For purposes of illustrating the process and fire combustion modified batt and not by way of limitation, the binder fiber is KoSa Type 254 Celbond® which is a bicomponent fiber with a polyester core and a copolyester sheath. The sheath component melting temperature is approximately 230° F. (110° C.). The binder fiber, alternatively, can be a polyester copolymer rather than a bicomponent fiber.

While the homogeneous mixture of nonwoven fibers and O-PAN fibers can be any of a number of suitable fiber blends, for purposes of illustrating the process and first blend, the mixture is comprised of binder finders in an amount sufficient for binding the fibers of the blend together upon application of heat at the appropriate temperature to melt the binder fibers. In one example, the binder fibers are in the range of approximately 5 percent to 50 percent by total volume of the blend. Preferably, the binder finders are present in the range of approximately 10 percent to 15 percent for a high loft batt, and in the range of approximately 15 percent to 40 percent for a densified batt, as those characteristics are discussed below. The relative percent volume of O-PAN fibers to carrier fibers in the remaining blend volume may range anywhere from 15 percent to 85 percent. In the preferred embodiment, the relative volume of O-PAN fibers to carrier fibers is about 50 percent to 50 percent. Thus, for example, a blend having 10 percent by volume of binder fibers and a 50 to 50 percent relative volume of O-PAN fibers to carrier fibers, the volume of O-PAN fibers and carrier fibers in the blend is 45 percent each. In another example, the volume of O-PAN fibers and carrier fibers in the blend is 45 percent each. In a further example, the volume of O-PAN fibers and carrier fibers having a 50 to 50 percent relative volume is 40 percent each in a blend having 20 percent by volume of binder fibers. In a further example, a blend having 20 percent binder fibers and a 75 percent to 25 percent relative volume mix of O-PAN fibers to carrier fibers, the volume of O-PAN fibers and carrier fibers is 60 percent and 20 percent, respectively. Blends having other percentages of binder, carrier and O-PAN fibers other than those specifically recited herein are also contemplated as being within the scope of the invention disclosed herein.

While a number of preferred embodiments have been shown and described herein, it is fully contemplated that modifications thereof may be made by one skilled in the art without departing from the spirit and the teachings of the invention. The embodiments described herein are exemplary only, and are not intended to be limiting. Many variations, combinations, and modifications of the invention disclosed herein are possible and are within the scope of the invention. Accordingly, the scope of protection is not limited by the description set out above but is defined by the claims which follow, that scope including all equivalents of the subject matter of the claims.

What is claimed is:

1. A fire retardant (FR) cover for use as a component of a composite furniture system, the FR cover comprising:
a resilient FR fiber batt comprising at least one FR material; and
a layer of material enclosing said FR fiber batt.

2. The FR cover of claim 1, wherein said FR fiber batt has first and second side surfaces and wherein said layer of material enclosing said FR fiber batt further comprises:
a top cover mated with said first side surface of said FR fiber batt; and
a backing mated with said second side surface of said FR fiber batt.

3. The FR cover of claim 2, wherein said backing is a woven fabric.

4. The FR cover of claim 2, wherein said backing is a nonwoven fiber batt.

5. The FR cover of claim 2, wherein said top cover, FR fiber batt and backing are quilted to one another.

6. The FR cover of claim 2, wherein said backing and said top cover each further comprises a first side surface and wherein said FR cover further comprises:
a first heat-activated layer of adhesive attaching said first side surface of said FR fiber batt to said first side surface of said cover; and
a second heat-activated layer of adhesive attaching said second side surface of said FR fiber batt to said first side surface of said backing.

7. The FR cover of claim 1, wherein said FR fiber batt further comprises at least one charring fiber.

8. The FR cover of claim 8, wherein said at least one charring fiber includes an oxidized polyacrylonitrile (O-PAN) fiber, an FR rayon fiber, or both.

9. The FR cover of claim 1 wherein said FR fiber batt is formed from a blend of FR fibers comprising O-PAN fibers, FR rayon fibers, a blend of O-PAN fibers and FR rayon fibers, modacrylic fibers, or a blend of FR rayon fibers and modacrylic fibers.

10. A composite furniture system comprising the FR cover of claim 1.

11. A fire retardant (FR) cover for use as a component of a composite furniture system, the FR cover comprising:
a resilient FR fiber batt comprising at least one inherently FR hybrid fiber, at least one polyester carrier fiber and binder; and
a layer of material enclosing said resilient FR fiber batt.

12. The FR cover of claim 11, wherein said inherently FR hybrid fiber is a part-organic and part-inorganic fiber.

13. The FR cover of claim 12, wherein said part-organic and part-inorganic fiber is a viscose staple fiber containing silicic acid.

14. The FR cover of claim 13, wherein said viscose staple fiber containing silicic acid is a blend of cellulosic fibers, a polysilicic acid and an aluminum compound.

15. The FR cover of claim 13, wherein said viscose staple fiber containing silicic acid is a blend of cellulosic fibers, sodium dioxide and sodium aluminate.

16. A composite furniture system, comprising a first component; and
a first fire retardant (FR) cover enclosing said first component;
wherein said FR cover comprises:
a resilient FR fiber batt; and
a layer of material enclosing said resilient FR fiber batt.

17. The composite furniture system of claim 16, wherein said first component is a mattress.

18. The composite furniture system of claim 16, wherein said first component is a mattress foundation.

19. The composite furniture system of claim 16, and further comprising:
a second component; and
wherein said first FR cover encloses said first component and said second component.

20. The composite furniture system of claim 19, wherein said first component is a mattress and said second component is a mattress foundation.

21. The composite furniture system of claim 16, and further comprising;
a second component; and
a second FR cover enclosing said second component;
wherein said second FR cover comprises:
a resilient FR fiber batt; and
a layer of material enclosing said resilient FR fiber batt.

22. The composite furniture system of claim 21, wherein said first component is a mattress and said second component is a mattress foundation.
